(19) United States
(12) Patent Application Publication
(10) Pub. No.: US 2024/0132751 A1
(43) Pub. Date: Apr. 25, 2024

(54) ENVIRONMENTALLY FRIENDLY WATERBASED ENGINEERING POLYMER COMPOSITIONS

(71) Applicant: ELANTAS EUROPE S.R.L., Collechio (IT)

(72) Inventors: Giovanni Loggi, San Benedetto del Tronto (IT); Lorenzo Spinelli, Colli del Tronto (IT); Giovanna Biondi, San Benedetto del Tronto (IT)

(21) Appl. No.: 18/277,606

(22) PCT Filed: Mar. 22, 2022
(86) PCT No.: PCT/EP2022/057611

§ 371 Date: Aug. 16, 2023

(30) Foreign Application Priority Data
Mar. 24, 2021 (EP) 21165032.0

(51) Int. Cl. C09D 179/08; C08G 73/10; C08G 73/14

(52) U.S. Cl. CPC C09D 179/08; C08G 73/1035; C08G 73/14

(57) ABSTRACT

The present invention relates to an aqueous composition comprising: ⋅Water; ⋅A reaction product obtained by reacting ⋅a polyamideimide polymer obtainable by reacting suitable starting materials in N-n-butyl pyrrolidone at a temperature in the range from 80-120° C. until a polymer is formed with an Mw of between 10000 to 40000 g/mol (Dalton) and a Mw/Mn ratio between 1.1 and 2, with ⋅an amine compound; ⋅Optionally an amine compound, and ⋅N-n-butylpyrrolidone. and the use thereof in coating compositions.

The present invention relates to aqueous compositions comprising an engineering polymer.

In US2015/0018466 an aqueous solution for coating systems is disclosed comprising a) water b) polyamideimide or polyether imide, c) an amine and d) a solvent. In previous compositions N-methylpyrrolidone (NMP) was used as a solvent for such coating systems, in US2015/0018466 alternative solvents are presented to overcome certain toxicologic issues associated with the use of NMP. The alternative solvents include acetoacetamides, guanidines, organic phosphates, piperidones, phthalates, sulfolane, dimethyl sulfones, dialkyl sulfoxide, di-pantothenyl, n-acetyl-caprolactam, or mixtures thereof. An aqueous solution of polyamideimide (PAI) is obtained by reacting solid PAI powder with an amine in a mixture of water and the alternative solvent at elevated temperature to form a polyamic acid-amine salt and then dissolving this salt in water. The obtained solutions have a solid content of 10 wt. % of PAI, which makes these solutions less attractive for use in, e.g., coatings, since a large amount of solvent needs to be removed upon drying/curing

In WO2017/011250 functional coating compositions are disclosed comprising an engineering polymer dissolved in a polar aprotic solvent. In known compositions solvents as gamma-butyrolactone, N-methyl-2-pyrrolidone (NM P), N-ethyl-2-pyrrolidone (NEP), N,N-dimethylformamide, and furfuryl alcohol are used. However, in view of the toxicologic issues associated with the use of NMP, in WO2017/011250 β-alkoxypropionamide is presented as an alternative solvent to replace NMP in these types of compositions. The coating compositions disclosed in this document have a solid content <30 wt. %, which means that after application of the coating a large amount of organic solvent needs to be removed upon drying/curing.

In US2017/349782 a process is disclosed for the preparation of an aqueous composition comprising a polyamidimide. In this process, a polyamideimide or polyamideamic acid resin powder is dissolved in a first solvent mixture comprising N-formyl morpholine (NFM) and a second solvent. Then the PAI-resin is precipitated from this solution and in a further steps, the PAI-resin is dissolved again in a second solvent mixture comprising N-bytyl pyrrolidone (NBP), ethylene glycol, and water. This process is rather complicated and at the end a PAI-resin solution is obtained with various organic solvents and a minor amount of water.

In JP2019026769 a process is disclosed for the preparation of a polyamideimide resin using N-bytyl pyrrolidone (NBP) as a solvent. A second organic solvent can be added to this solution and the composition can be used as a coating with excellent moisture resistance. This document does not disclose the preparation of an aqueous composition comprising a PAI-resin.

There is a need for aqueous polyamideimide solutions having a solid content >20 wt. %, preferably >25 wt. % which can be used for various types of (specialty) coating applications.

The present invention relates to an aqueous solution comprising:
a. Water;
b. A reaction product obtained by reacting
   b1. a polyamideimide polymer obtainable by reacting suitable starting materials in N-n-butyl pyrrolidonepyrrolidone at a temperature in the range from 80-120° C. until a polymer is formed with a Mw of between 10000 to 40000 g/mol (Dalton) and a Mw/Mn ratio between 1.1 and 2, with
   b2. an amine compound;
c. Optionally an amine compound, and
d. N-n-butylpyrrolidone.

Preparation of Polyamideimide Polymer

The polyamideimide resins used in the current invention can be prepared from various starting materials, such as polycarboxylic acids or their anhydrides in which two carboxyl groups are in a vicinal position and in which there must be at least one further functional group, and from polyamines having at least one primary amino group which is capable of forming an imide ring, or from compounds having at least 2 isocyanate groups. The polyamideimides can also be obtained by reacting polyamides, polyisocyanates which contain at least 2 NCO groups, and cyclic dicarboxylic anhydrides which contain at least one further group which can be subjected to reaction by condensation or addition.

Furthermore, it is also possible to prepare the polyamideimides from diisocyanates or diamines and dicarboxylic acids, provided one of the components already contains the imide group. For instance, it is possible to react a tricarboxylic anhydride with a diprimary diamine in an initial step to give the corresponding diimidocarboxylic acid, which is then reacted with a diisocyanate to form the polyamideimide.

For the preparation of the polyamideimides, preference is given to the use of tricarboxylic acids or anhydrides thereof in which 2 carboxyl groups are in a vicinal position. Preference is given to the corresponding aromatic tricarboxylic anhydrides, for example trimellitic anhydride, naphthalene tricarboxylic anhydrides, bisphenyl tricarboxylic anhydrides, and other tricarboxylic acids having 2 benzene rings in the molecule and 2 vicinal carboxyl groups, such as the examples given in DE-A 19 56 512. Very particular preference is given to the employment of trimellitic anhydride.

As amine component it is possible to employ the diprimary diamines already described in connection with the polyamidocarboxylic acids. The possibility also exists, furthermore, of employing aromatic diamines containing a thiadiazole ring, for example 2,5-bis(4-aminophenyl)-1,3,4-thiadiazole, 2,5-bis(3-aminophenyl)-3,3,4-thiadiazole, 2-(4-aminopbenyl)-5-(3-aminophenyl)-1,3,4-thiadiazole, and also mixtures of the various isomers.

Diisocyanates suitable for the preparation of the polyamideimides are aliphatic diisocyanates, such as tetramethylene, hexamethylene, heptamethylene and trimethylhexamethylene diisocyanates; cycloaliphatic diisocyanates, for example isophorone diisocyanate, ω,ω′-diisocyanato-1,4-dimethylcyclohexane, cyclohexane 1,3-diisocyanate, cyclohexane 1,4-diisocyanate, 1-methylcyclohexane 2,4-diisocyanate and dicyclohexyl-methane 4,4′-diisocyanate; aromatic diisocyanates, for example phenylene, tolylene, naphthylene and xylylene diisocyanates, and also substituted aromatic systems, for example diphenyl ether, diphenyl sulphide, diphenyl sulphone and diphenylmethane diisocyanates; mixed aromatic-aliphatic and aromatic-hydroaromatic diisocyanates, for example 4-isocyanatomethylphenyl isocyanate, tetrahydronaphthylene 1,5-diisocyanate and hexahydrobenzidine 4,4′-diisocyanate. Preference is given to the use of 4,4′-diphenylmethane diisocyanate, 2,4- and 2,6-tolylene diisocyanate and hexamethylene diisocyanate.

To prepare a polyamideimide polymer that is soluble in water, the polyamidimide is reacted with an amine to form polyamic acid-amine salt. Normally this is done at a temperature between 50° C. and 80° C. for a time between 4 to 6 hours or alternatively until the desired solid content is reached.

Examples of suitable amines that can be used to prepare the polyamic acid-amine salt include triethylamine, dimethyl ethanolamine, ethyl 2-hydroxyethyl amine, tributyl amine, tris (2-hydroxyethyl) amine, N, N-dimethylaniline, morpholine, pyridine, N-methyl pyrrole, ethyl bis(2-hydroxyethyl) amine, tetramethyl guanidine and mixtures thereof.

To prepare an aqueous solution according to the present invention, water is added to the polyamic acid-amine salt or, alternatively, an aqueous solution containing an amine is added.

The amine that is optionally present in the aqueous solution according to the present invention can be the same or different from the amine that is used to prepare a polyamic acid-amine salt, as indicated above.

It was found that aqueous composition of the present invention based on a polyamideimide resin that shows the beneficial properties necessary to qualify as a functional coating with special properties, can only be obtained when the polyamideimide resin is prepared in NBP under well-defined reaction conditions. It was found that the reaction temperature should not be too high, preferably in the range from 80 to 130° C., more preferably in the range from 80 to 120° C. It was found that when the reaction temperature is above 130° C., the reaction is too fast and uncontrolled to obtain a polyamideimide resin with a Mw of at least 10000 g/mol and a Mw/Mn ratio between 1,1 and 2. When the reaction temperature is below 80° C. the reaction is very slow, if occurring at all, to be useful in practice for the manufacture of a polyamideimide resin.

It was further found to be beneficial to have a small amount of moderator compound, such as a low molecular weight monocarboxylic acid, present in the reaction mixture. Examples of suitable low molecular weight monocarboxylic acids include (C1-C10) monocarboxylic acids or C4-C6 branched monocarboxylic acids, such as formic acid, acetic acid, propionic acid and others. The amount of the low molecular weight monocarboxylic acid in the reaction mixture should be small, for example, from 2 to 4 mol %, based on the amount of anhydride, in case the polyamideimide resin is prepared using an anhydride as starting material.

The present invention also relates to a coating composition that can be used as a functional coating to provide non-stick or reduced friction properties. Such coatings can be prepared by adding one or more dry lubricants, such as fluoropolymers, graphite, graphene, molybdenum disulphide, boron nitride, silicones, and the like, embedded in or coupled to a binder medium to the composition. Typically, these dry lubricants are present in the composition in an amount from 0.5 to 20 wt. %, based on the solid content of the composition.

The coating composition may optionally include one or more additional components, such as pigments, additional solvents, functional fillers, additives, and acidic or alkaline additives.

If pigments are present in the coating composition, they are present in an amount in the range of 0.1 wt. % to 50 wt. %, based on the solid content of the composition, alternatively in the range of 0.5-20 wt. %, based on the solid content of the composition.

The coating composition may also contain additional solvents, in addition to the NBP solvent. Such other solvents may be present in an amount of 0.1-20 wt. %, based on the total content of the coating composition, alternatively in the range of 0.5 to 10 wt. %, based on the total content of the coating composition.

The coating composition may also contain one or more functional fillers. Such functional fillers may provide corrosion protection, higher filling factor, surface texturing, improved hardness or other features. Exemplary functional fillers include silicon carbide, barium sulphate, pyrogenic silica, wollastonite, alumina, talc, mica, silica, zinc phosphates, aluminium phosphates, waxes, and the like.

If such functional fillers are present, they are typically present in an amount from 0.1 wt. % to 50 wt. %, based on the solid content of the coating composition, alternatively in the range of 0.5-20 wt. %, based on the solid content of the coating composition.

The coating composition may also contain further functional additives, such defoamers, surface wetting agents, flow agents, pigment wetting additives, thickeners, fillers, and additives that change the electric conductivity or other features.

If such functional additives are present, they are typically present in an amount from 0.1 wt. % to 20 wt. %, based on the solid content of the coating composition, alternatively in the range of 0.5-10 wt. %, based on the solid content of the coating composition.

The coating composition may also contain acidic or alkaline additives, such as dimethylethanolamine, methylamine, dimethylamine, triethanolamine, triethylamine, aminomethoxypropanol, diisopropylamine, ammonia, acetic acid, formic acid, citric acid and the like. Such additives may act as pH correctors or flash rust inhibitors. If such acidic or alkaline additives are present in the composition, they are typically present in an amount from 0.5 to 20 wt. %, based on the total content of the coating composition, alternatively in an amount from 1 to 10 wt. %, based on the total content of the coating composition.

The coating composition according to the present invention typically has the following composition, (wherein the wt. % are based upon the weight of the composition as a whole)
20-30 wt. % of a polyamic acid amine salt (i.e. the reaction product of polyamideimide an amine);
30-40 wt. % of NBP
15-20 wt. % of an amine;
15-25 wt. % of water, and
0-10 wt. % of other ingredients

The coating composition according to the present invention with the above composition typically has a viscosity in the range of 500 to 4000 mPa·s (500 to 4000 cPs), where the viscosity is measured at 22° C. with a HAAKE VISCOTESTER 550 at shear rate of 160 s⁻¹ and coaxial cylinder measuring system for a time of two minutes.

The coating composition according to the present invention is normally applied to a substrate. The substrate is selected from the group consisting of metals, ceramic materials, plastics, composites, and minerals.

Metals used as a substrate for the coatings according to the present invention include substrates from stainless steel, aluminium, copper, tinplate and carbon steel.

Ceramic materials used as a substrate for the coatings according to the present invention include glasses like borosilicate glass, porcelain enamels, various fired clays and other refractory materials.

Plastics and composites used as a substrate for the coatings according to the present invention include high melting point plastics and composites, such as plastics having a melting point higher than the cure temperature of the coating formulation, including polyester, polypropylene, ABS, polyethylene, carbon fiber epoxy composites, and glass fiber epoxy composites. Minerals used as a substrate for the coatings according to the present invention include micas, basalts, aluminas, silicas, and wollastonites, marble and granite.

The substrate can be a portion of an article such as a pan or another article of cookware.

The substrate may be a rigid substrate or a flexible substrate. Examples of rigid substrates include cookware, bakeware, cans, coils, moulds, small electrical appliances, fasteners, reprographic rollers, bearings, engine piston skirts, and other suitable substrates. Examples of flexible substrates include glass cloth of the type commonly used in applications such as food conveyer belts for continuous ovens, architectural fabrics of the type used in stadium roofs and radar domes, as well as heat sealing belts, circuit boards, cooking sheets, and tenting fabrics, for example. “Glasscloth” or “glass cloth” is a textile material made of woven fibers such as, for example, linen, glass, or cotton. Other flexible substrates that may be coated with the present coating compositions include any material including natural or synthetic fibers or filaments, including staple fiber, fiberfill, yarn, thread, textiles, nonwoven fabric, wire cloth, ropes, belting, cordage, membranes and webbing, for example. Exemplary fibrous materials which may be coated with the present coating compositions include natural fibers, such as vegetable, animal, and mineral fibers, including cotton, cotton denim, wool, silk, ceramic fibers, and metal fibers, as well as synthetic fibers, such as knit carbon fabrics, ultra-high molecular weight polyethylene (UHMWPE) fibers such as Dyneema® available from Royal DSM NV, poly(ethylene terephthlalate) (PET) fibers, para-aramid fibers, including poly-paraphenylene terephtalamide, such as Twaron® available from Teijin Aramid, Rayon fibres, such as CORDENKA® fibres available from Cordenka GmbH & Co KG, polyphenylene sulfide fibers, polypropylene fibers, polyacrylic fibers, polyacrylonitrile (PAN) fibers, polyamide fibers (nylon), and nylon-polyester fibers.

Method of Coating

The coating composition can be prepared by any standard formulation technique such as simple addition and low shear mixing. The coating composition may be applied directly to the substrate as a base layer or primer, or may be applied over a basecoat or primer and/or a midcoat by any known technique, such as spray coating, curtain coating and roller coating, and is then cured to provide a coated substrate with a coating having improvements in gloss, non-stick performance, and abrasion and scratch resistance. Typically, basecoats will be applied by spray coating, curtain coating and roller coating, while midcoats and topcoats will be applied by roller coating. The particular compositions of the primer and/or midcoat may vary widely, and are not thought to be critical with respect to the improved properties demonstrated by the coatings disclosed herein.

In one exemplary embodiment, the coating composition is applied to the substrate, followed by drying. In an illustrative embodiment, drying may take place at a drying temperature in the range of 40° C. to 130° C., alternatively in the range of 75 to 115° C. In an illustrative embodiment, drying may comprise drying at the drying temperature between 30 seconds and 10 min, or longer. In one exemplary embodiment, the coating composition is dried by air drying at ambient temperature. In one exemplary embodiment, the coating composition is heat cured to the substrate. In an illustrative embodiment, curing may take place at a curing temperature in the range of 220° C. to 450° C. for a time period between 3 to 20 minutes or longer.

The coating compositions are typically applied to a dry film thickness (DFT) in the range of below 5 microns to 60 microns, or thicker, depending on the application.

The coating composition of the present invention can be used as an undercoat. The undercoat may be a basecoat, which is a coating applied directly to an underlying substrate (sometimes referred to as a primer). The present coating compositions may also be overcoats, which are applied over an underlying undercoat. In these embodiments, the present coating compositions may take the form of a midcoat, in which the coating is applied over an underlying undercoat and beneath a covering coating or topcoat, or the present coating compositions may take the form of a topcoat, in which the coating is applied over an underlying undercoat with the coating remaining exposed to the external environment. In other embodiments, the present coating composition may be applied directly to a substrate to form a single-layer coating in direct contact with the substrate whereby the coating is not applied over any undercoats with the coating remaining exposed to the external environment.

### EXAMPLES

### Example 1: Preparation of Polyamideimide

18.08 parts by weight (pbw) of trimellitic anhydride, 23.5 pbw of 4,4′-diphenylmethane diisocyanate, 0.12 pbw of formic acid and 58.29 pbw of NBP were charged in a reaction vessel and heated up to 85° C. The mixture was held for 2 hours at 85° C., then slowly heated up to 100° C. The temperature in the reaction vessel was kept at this temperature for two hours. Thereafter, the heating of the reaction vessel was stopped and a polyamideimide solution in NBP was obtained. The Mw and Mn of the obtained polyamideimide was measured in accordance with DIN 55672-2 at 16000 g/mol and 10000 g/mol, respectively, hence the polyamideimide in solution had a Mw/Mn ration of 1.6.

### Example 2: Preparation of Polyamideimide Solution in Water

62.62 pbw of the polyamideimide solution in NBP produced according to example 1 was reacted with 5.52 pbw of dimethylethanolamine at a temperature between 50 and 80° C. for a time between 4 and 6 hours. The obtained polyamic acid amine salt (PAAA-salt) was dissolved in 7.37 pbw of water and kept under stirring at 70-75° C. until complete homogeneous solution was obtained. An aqueous solution containing 50% by weight of dimethylethanolamine was added until a solid content of 25.0% was obtained. The solid content was measured by weighting 2.5 gr of product in a 5 cm diameter disk, then putting it in an oven for 20′ at 250° C. This PAAA-salt solution in water has a viscosity of 2420 mPa·s at 22° C. measured with HAAKE VISCOTESTER 550 at shear rate of 160 s⁻¹ and coaxial cylinder measuring system for a time of two minutes. The final composition of the obtained product is wt. % PAAA-salt, 37 wt. % NBP, 18 wt. % DMEA and 20 wt. % water, wherein the wt. % is based upon the total weight of the composition.

### Example 3: Preparation of Low Viscosity Polyamideimide Solution in Water

62.62 pbw of the polyamideimide solution in NBP produced according to example 1 was reacted with 5.52 pbw of dimethylethanolamine between 50 and 80° C. for a time between 6 and 8 hours. The obtained polyamic acid amine salt (PAAA-salt) was dissolved in 7.37 pbw of water and kept under stirring at 70-75° C. until complete homogeneous solution was obtained. An aqueous solution containing 50% by weight of dimethylethanolamine was added until a solid content of 25.0% was obtained. This PAAA-salt solution in water has a viscosity of 1550 mPa·s at 22° C. measured with HAAKE VISCOTESTER 550 at shear rate of 160 s⁻¹ and coaxial cylinder measuring system for a time of two minutes. The final composition of the obtained product is 25% PAAA-salt, 37% NBP, 18% DMEA and 20% water, wherein the wt. % is based upon the total weight of the composition.

### Example 4 Preparation of High Solid Polyamideimide Solution in Water

62.62 pbw of the polyamideimide solution in NBP produced according to example 1 was reacted with 5.52 pbw of dimethylethanolamine between 50 and 80° C. for a time between 4 and 6 hours. The obtained polyamic acid amine salt (PAAA-salt) was dissolved in 7.37 pbw of water and kept under stirring at 70-75° C. until complete homogeneous solution was obtained. An aqueous solution containing 50% by weight of dimethylethanolamine was added until a solid content of 28.5% was obtained. This PAAA-salt solution in water has a viscosity of 2420 mPa·s at 22° C. measured with HAAKE VISCOTESTER 550 at shear rate of 160 s⁻¹ and coaxial cylinder measuring system for a time of two minutes. The final composition of the obtained product is 28.4% PAAA-salt, 42% NBP, 13.6% DMEA and 16% water, wherein the wt. % is based upon the total weight of the composition.

### Example 5: Preparation of Polyamideimide Solution in Water. (Comparative Example)

62.62 pbw of the polyamideimide solution in NBP produced according to example 1 was used to precipitate the PAI from the solution by using a non-solvent (ethanol). The obtained fine powder was dried. Thereafter, the 22.54 pbw of the PAI powder was reacted with 4.97 pbw of dimethylethanolamine. The obtained polyamic acid amine salt was dissolved in 6.66 pbw of water and kept under stirring at 70-75° C. until a complete homogeneous solution was obtained. An aqueous solution containing 50% by weight of dimethylethanolamine was added to obtain an aqueous solution with a viscosity that is normally used for coating applications. The solution had a solid content of about 10%.

1. Aqueous composition comprising:
a. water;
b. a reaction product obtained by reacting components comprising:
b1. a polyamideimide polymer obtainable obtained by reacting suitable starting materials in N-n-butyl pyrrolidone at a temperature in the range from 80-120° C. until a polymer is formed with an Mw of between 10000 to 40000 g/mol (Dalton) and a Mw/Mn ratio between 1.1 and 2 (wherein Mw and Mn are measured in accordance with DIN 55672-2), with
b2. an amine compound; and
c. N-n-butylpyrrolidone.

2. The aqueous composition of claim 1, wherein the suitable starting materials include a mixture comprising tricarboxylic acid, or an anhydride thereof, having 2 carboxyl groups in a vicinal position, a diisocyanate, and a low molecular weight monocarboxylic acid.

3. A coating composition comprising the aqueous solution of claim 1 and one or more of a dry lubricant, a pigment, an additional solvent, a functional filler, a functional additive, an acidic additive, or an alkaline additive.

4. The coating composition of claim 3, comprising
20-30 wt. % of a polyamic acid amine salt, the salt comprising (i.e. the reaction product of the polyamideimide polymer and an amine compound);
30-40 wt. % of NBP;
15-20 wt. % of an amine;
15-25 wt. % of water; and
0-10 wt. % of other ingredients;
wherein the wt. % are based upon the total content of the composition.

5. The coating composition of claim 4, comprising
from 0.5 to 20 wt. %, based on the solid content of the composition of dry lubricants;
from 0.0 wt. % to 50 wt. %, based on the solid content of the composition of one or more pigments;
from 0.0-20 wt. %, based on the total content of the coating composition of additional solvent;
from 0.0 wt. % to 50 wt. %, based on the solid content of the coating composition of functional fillers;
from 0.0 wt. % to 20 wt. %, based on the solid content of the coating composition of functional additives;
from 0.0 to 5 wt. %, based on the total content of the coating composition of acidic or alkaline additives.

6. A method of coating a substrate comprising coating a substrate with the coating composition of claim 3.

7. The method according to claim 6, wherein the coating composition is applied to the substrate, followed by drying at a drying temperature in the range of 40° C. to 130° C.

8. A coating layer on a substrate obtained by coating the substrate with a coating composition of claim 3, followed by drying at a drying temperature in the range of 40° C. to 130° C., wherein the coating layer has a dry film thickness (DFT) in the range of below 5 microns to 60 microns.

9. The aqueous composition of claim 1, the composition further comprising an amine compound.

10. The aqueous composition of claim 9, wherein the suitable starting materials include a mixture comprising tricarboxylic acid, or an anhydride thereof, having 2 carboxyl groups in a vicinal position, a diisocyanate, and a low molecular weight monocarboxylic acid.

11. A coating composition comprising the aqueous solution of claim 9 and one or more of a dry lubricant, a pigment, an additional solvent, a functional filler, a functional additive, an acidic additive, or an alkaline additive.

12. The coating composition of claim 11, comprising
20-30 wt. % of a polyamic acid amine salt, the salt comprising the reaction product of the polyamideimide polymer and an amine compound;
30-40 wt. % of NBP;
15-20 wt. % of an amine;
15-25 wt. % of water; and
0-10 wt. % of other ingredients;
wherein the wt. % are based upon the total content of the composition.

13. The coating composition of claim 12, comprising
from 0.5 to 20 wt. %, based on the solid content of the composition of dry lubricants;
from 0.0 wt. % to 50 wt. %, based on the solid content of the composition of one or more pigments;
from 0.0-20 wt. %, based on the total content of the coating composition of additional solvent;
from 0.0 wt. % to 50 wt. %, based on the solid content of the coating composition of functional fillers;
from 0.0 wt. % to 20 wt. %, based on the solid content of the coating composition of functional additives; and
from 0.0 to 5 wt. %, based on the total content of the coating composition of acidic or alkaline additives.

14. A method of coating a substrate comprising coating a substrate with the coating composition of claim 11.

15. The method according to claim 14, wherein the coating composition is applied to the substrate, followed by drying at a drying temperature in the range of 40° C. to 130° C.

16. A coating layer on a substrate obtained by coating the substrate with a coating composition of claim 11, followed by drying at a drying temperature in the range of 40° C. to 130° C., wherein the coating layer has a dry film thickness (DFT) in the range of below 5 microns to 60 microns.
